(19) United States
(12) Patent Application Publication
(10) Pub. No.: US 2017/0019780 A1
(43) Pub. Date: Jan. 19, 2017

(54) METHOD FOR CONTROLLING CAPABILITY OF RADIO ACCESS TECHNOLOGY AND USER EQUIPMENT USING THE SAME

(71) Applicant: Acer Incorporated, New Taipei City (TW)

(72) Inventor: Chu-Hsiang Hsu, New Taipei City (TW)

(21) Appl. No.: 14/988,721

(22) Filed: Jan. 5, 2016

(30) Foreign Application Priority Data
Jul. 13, 2015 (TW) 104122528

(51) Int. Cl. H04W 8/18; H04W 76/02; H04B 1/3816; H04W 60/00

(52) U.S. Cl. CPC H04W 8/183; H04W 60/005; H04W 76/025; H04B 1/3816; H04W 88/06

(57) ABSTRACT

A method for controlling capability of radio access technology and a user equipment using the same are provided. The user equipment supports a first radio access technology (RAT) and a second radio access technology, and the method includes following steps. An elementary field (EF) stored in a universal integrated circuit card (UICC) is read. It is determined whether a data field of the elementary field is available, wherein the data field stores service information related to the second radio access technology. It is determined whether to activate or to deactivate the second radio access technology according to whether the data field is available or not.

### CROSS-REFERENCE TO RELATED APPLICATION

This application claims the priority benefit of Taiwan application serial no. 104122528, filed on Jul. 13, 2015. The entirety of the above-mentioned patent application is hereby incorporated by reference herein and made a part of this specification.

### BACKGROUND OF THE INVENTION

Field of the Invention

The invention relates to a mobile communication technology, and particularly relates to a method for controlling capability of radio access technology and a user equipment (UE) using the same.

Description of Related Art

Along with quick development of mobile communication technology, people can use user equipment (UE) such as mobile phones, tablet personal computers (PCs), etc. to make phone calls, send messages or access the Internet at any time anywhere. To cope with a market demand or other factors, manufacturers of the UEs try their best to equip their products with chips or modules supporting the latest mobile communication technology (for example, long term evolution (LTE), etc.), so that the UEs supporting, for example, the LTE gradually become popular in the market. Generally, when a mobile network user owns a UE supporting, for example, the LTE, a universal integrated circuit card (UICC) (for example, a subscriber identity module (SIM) card, a universal subscriber identity module (USIM) card, etc.) is still required to be changed to a USIM card supporting the LTE in order to enjoy a network service with a high speed transmission.

However, not all of the mobile network users have the demand for changing the UICC, and in a current third generation partnership project (3GPP) standard, capability consistency of processing devices at a network terminal is not defined. Therefore, even if the UE supporting the LTE (or a fourth generation (4G)) is loaded with the USIM card only supporting the 3G wireless communication technique, such UE can still use a second generation (2G)/3G network service. In this case, the UE is limited by the capability of the UICC and cannot perform communication through an LTE network, though the UE still keeps searching the LTE network and tries to camp on the LTE network, which causes a waste of power and shortens a power usage time of the UE. Moreover, such loading mode associated with the UICC may lead to following problems. For example, FIG. 1 is an example that the UE encounters a problem. Referring to FIG. 1, a UE 101 with the USIM card only supporting the 3G wireless communication technique is originally located in a service coverage range 113 of base station 103 supporting 3G. When the UE 101 moves to a service coverage range 115 of a base station 105 supporting 4G, the UE 101 tries to perform a registration procedure with the base station 105 supporting 4G. At this moment, the base station 105 rejects the registration of the UE 101, and a network state of the UE 101 is suddenly changed to “no service”. Then, the UE 101 selects to camp on a base station 103 supporting 3G to obtain a 3G network service. Therefore, a resolution is required to resolve the above problem. If the UE 101 keeps moving to move back and forth between the service coverage ranges of the 3G base station and the 4G base station, the UE 101 is probably alternated between the network states of “service” and “no service”, which may cause inconvenience to the user, and the UE 101 is also required to consume extra resources to register in and reconnect to different base stations.

### SUMMARY OF THE INVENTION

The invention is directed to a method for controlling capability of radio access technology and a user equipment (UE) using the same, by which the UE is prevented to perform registration in a radio access network that is not supported by a universal integrated circuit card (UICC), so as to save power of the UE and provide better user experience for a wireless communication service.

The invention provides a method for controlling capability of radio access technology, which is adapted to a UE supporting a first radio access technology (RAT) and a second radio access technology. The method includes following steps. An elementary file (EF) stored in a universal integrated circuit card (UICC) is read. It is determined whether a data field of the elementary file is available, wherein the data field stores service information related to the second radio access technology. It is determined whether to deactivate or activate the second radio access technology according to whether the data field is available or not.

The invention provides a user equipment supporting a first radio access technology and a second radio access technology. The user equipment includes a transceiver, a storage unit and a processor. The transceiver is configured to transmit and receive a radio signal, and the storage unit is configured to store network information related to a radio access network. The processor is coupled to the transceiver and the storage unit, and is configured for executing: reading an elementary file stored in a universal integrated circuit card; determining whether a data field of the elementary file is available, wherein the data field stores service information related to the second radio access technology; and determining whether to deactivate or activate the second radio access technology according to whether the data field is available or not.

According to the above description, the user equipment of the invention supports the first radio access technology and the second radio access technology, and determines to directly deactivate or activate the second radio access technology according to the data field of the elementary file stored in the UICC. The data field indicates whether a service related to the second radio access technology is available or not. In this way, when the user equipment of the invention is loaded with the UICC not supporting the second radio access technology, the user equipment is avoided to frequently receive a camp-on rejection message from a radio access network corresponding to the second radio access technology, and a chance of occurring a network state of “no service” is decreased.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an example that a user equipment (UE) encounters a problem.

FIG. 2 is a schematic diagram of a communication system according to an embodiment of the invention.

FIG. 3 is a block diagram of a UE according to an embodiment of the invention.

FIG. 4 is a block diagram of a universal integrated circuit card (UICC) according to an embodiment of the invention.

FIG. 5 is a flowchart illustrating a method for controlling capability of radio access technology according to an embodiment of the invention.

FIG. 6 is a flowchart illustrating a method for controlling capability of radio access technology according to an embodiment of the invention.

FIG. 7 is a flowchart illustrating details of a step S604 of FIG. 6 according to an exemplary embodiment of the invention.

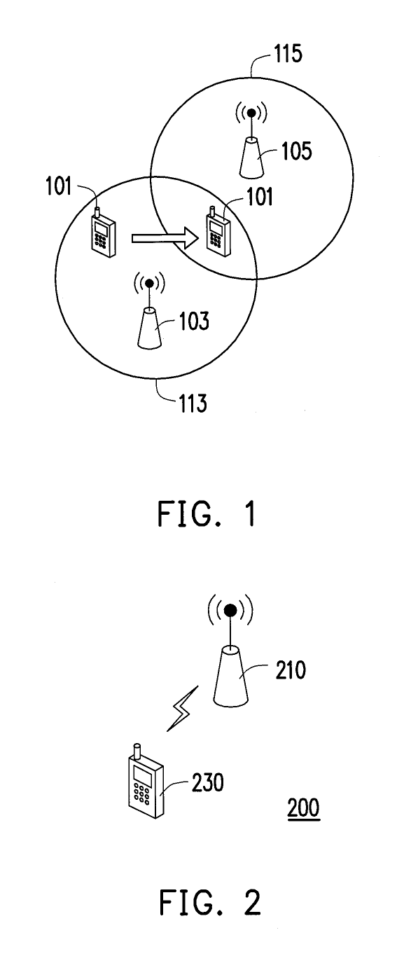

### DESCRIPTION OF EMBODIMENTS

If a user equipment (UE, for example, a mobile phone, a tablet personal computer (PC), etc.) supports at least two radio access technologies (for example, a first radio access technology (RAT) and a second RAT) but is loaded with a universal integrated circuit card (UICC) only supporting one RAT (for example, the first RAT), the UE still tries to camp on a radio access network corresponding to another RAT (for example, the second RAT) that is not supported by the UICC. Generally, besides that the UICC stores subscriber data, the UICC further stores a service table in which a table content is defined by a mobile network operator. The UE of the embodiment of the invention can determine whether to directly deactivate the second RAT that is not supported by the UICC according to a specific field of the service table stored in the UICC. A plurality of embodiments complied with the spirit of the invention is provided below, and those skilled in the art can suitably adjust the embodiments according to an actual requirement without being limited by the content of the following descriptions.

FIG. 2 is a schematic diagram of a communication system according to an embodiment of the invention. Referring to FIG. 2, the communication system 200 includes a base station 210 and a UE 230. It should be noticed that in the embodiment of FIG. 2, only one base station 210 and one UE 230 is taken as an example for description, though the invention is not limited thereto.

The base station 210 may have various implementations, which includes (but is not limited to) a home evolved node B (HeNB), eNB, an advanced base station (ABS), a base transceiver system (BTS), an access point, a home base station, a relay, a scatter, a repeater, an intermediate node, an intermediary and/or a communication base station based on satellite.

In the one of the embodiments, the base station 210 serves as a network entity supporting a radio access network corresponding to an RAT (for example, 2G, 3G, 4G, etc.), and the UE 230 can be connected to a core network through the base station 210. The aforementioned radio access network is, for example, a global system for mobile (GSM) radio access network (GRAN), a GSM enhanced data rate for GSM evolution (EDGE) radio access network (GERAN), a universal mobile telecommunications system (UMTS) radio access network (UTRAN), an evolved universal terrestrial radio access network (E-UTRAN).

The UE 230 may have various implementations, which includes (but is not limited to) a mobile station, an advanced mobile station (AMS), a server, a client, a desktop computer, a notebook, a network computer, a work station, a personal digital assistant (PDA), a tablet personal computer (PC), a scanner, a telephone device, a pager, a camera, a television, a handheld video game device, a music device, a wireless sensor, etc.

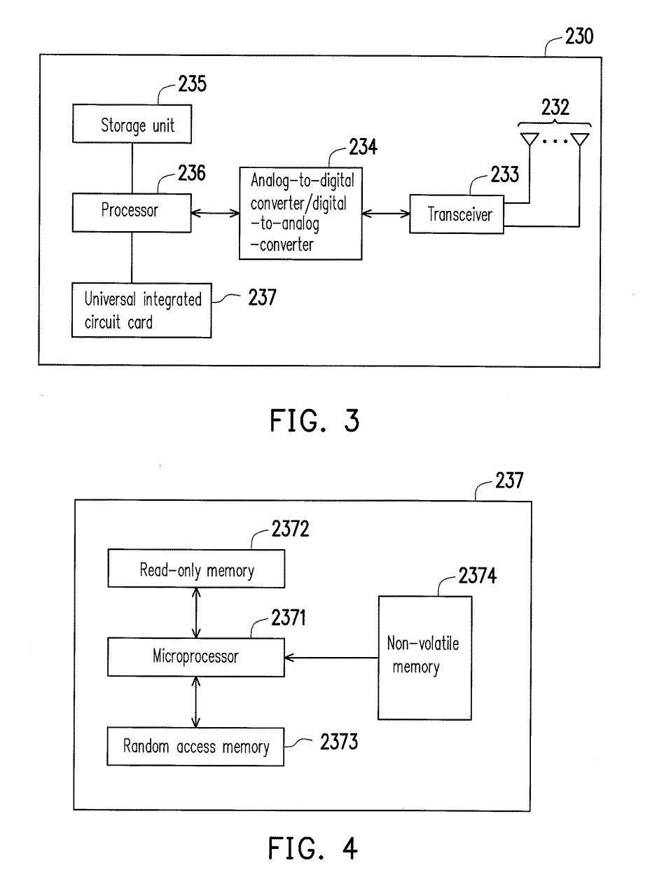

FIG. 3 is a block diagram of the UE according to an embodiment of the invention. The UE 230 can be at least represented by functional elements shown in FIG. 3. The UE 230 at least includes (but is not limited thereto) a transceiver 233, an analog-to-digial converter (ADC)/digital-to-analog converter (DAC) converter 234, a processor 236, a storage unit 235, one or a plurality of antenna units 232 and a UICC 237. The transceiver 233 receives a downlink signal and transmits an uplink signal in a wireless manner The transceiver 233 can also perform operations such as low noise amplifying, impedance matching, frequency mixing, frequency up-converting, frequency down-converting, filtering, amplifying, etc. The ADC/DAC 234 is configured to convert a signal from the analog signal format to a digital signal format during an uplink signal processing period, and convert the signal from the digital signal format to the analog signal format during a downlink signal processing period.

The storage unit 235 can be a fixed or movable random access memory (RAM) of any type, a read-only memory (ROM), a flash memory, a hard disk or other similar devices or a combination of the above devices. The storage unit 235 is configured to store network information (for example, PLMN information and RAT information) related to a radio access network.

The processor 236 is configured to process a digital signal and execute a procedure according to an exemplary embodiment of the invention (for example, a UICC initialization procedure, a registration procedure, a tracking area updating procedure, a cell reselection procedure, etc.). Moreover, the processor 236 is coupled to the storage unit 235, and the storage unit 235 stores program codes, device configurations, codebooks, buffered or permanent data, and also records a plurality of modules executed by the processor 236.

The function of the processor 236 can be implemented by using a programmable unit such as a microprocessor, a micro controller, a digital signal processing (DSP) chip, a field programmable gate array (FPGA), etc. The function of the processor 236 can also be implemented by using an independent electronic device or an integrated circuit (IC), and the processor 236 can also be implemented by hardware or software. It should be noted that according to an actual design requirement of those skilled in the art, the UE 230 may have one or a plurality of processors 236, so as to integrate or respectively execute functions of a modem, sensing, display, etc., though the invention is not limited thereto.

FIG. 4 is a block diagram of the UICC according to an embodiment of the invention. Referring to FIG. 4, the UICC 237 (for example, a subscriber identity module (SIM) card, a universal subscriber identity module (USIM) card, a removable user identity module (RUIM), etc.) includes a microprocessor 2371, a ROM 2372, a RAM 2373 and a non-volatile memory 2374. The ROM 2372 stores a card operating system (COS), and the microprocessor 2371 can execute commands in the COS. The RAM 2373 is configured to store subscriber data of the user, protocol setting parameters related to the RAT and service configuration dada. Further, a file structure of the non-volatile memory 2374 is a hierarchical file structure, and the non-volatile memory 2374 stores a plurality of elementary files (EFs) and/or dedicated files (DFs). The microprocessor 2371 can select, read or update the EF in the non-volatile memory 2374 according to a control command sent by the processor 236 of the UE 230.

It should be noted that the EFs stored in the UICC 237 include data and parameters used for camping on the radio access network, such that the UE 230 loaded with the UICC 237 can camp on the core network according to the EFs to execute a communication function. Namely, related information of the most advanced RAT supported by the UICC 237 can be obtained from the UICC 237 (for example, the related information is stored in a field of a related EF in a subscriber identity module such as SIM, USIM, or RUIM, etc.). In the embodiment of the invention, the UE 230 supports the first RAT and the second RAT, where the first RAT is different to the second RAT. For example, the first RAT can be a 3G RAT and the second RAT can be a 4G RAT, though the invention is not limited thereto. In other words, the UE 230 can support at least two RATs, and the processor 236 can support communication protocols of at least two RATs (for example, various procedures, packets, frequency bands and data, etc., in a physical layer, a data link layer and a network layer). The UE 230 is loaded with the UICC 237, and the UICC 237 supports the first RAT, but may support or does not support the second RAT.

According to the above descriptions, the processor 236 sends a read command to the microprocessor 2371 to read the EF stored in the non-volatile memory 2374. In this way, the processor 236 determines whether a data field in the EF is available, so as to determine whether to deactivate the second RAT. The data field stores service information related to the second RAT. The processor 236 determines whether the data field is available according to whether the data field exists or an identification bit in the data field. For example, the EF may include a service table. If the UICC 237 is a USIM card, the processor 236 reads a USIM service table (UST) EF (EF_{UST}), though the invention is not limited thereto. In the embodiment that the EF stores the service table, the data field may store one identification bit, and the identification bit indicates whether a service related to the second RAT is available. Moreover, in the embodiment that the EF stores the communication protocol setting parameters, the data field may also include registration related information or various identification codes related to the second RAT. For example, the EF may include an evolved packet system non-access stratum (EPS NAS) security contest EF (EF_{EPSNSC}), and stores EPS security information used for camping on the 4G network.

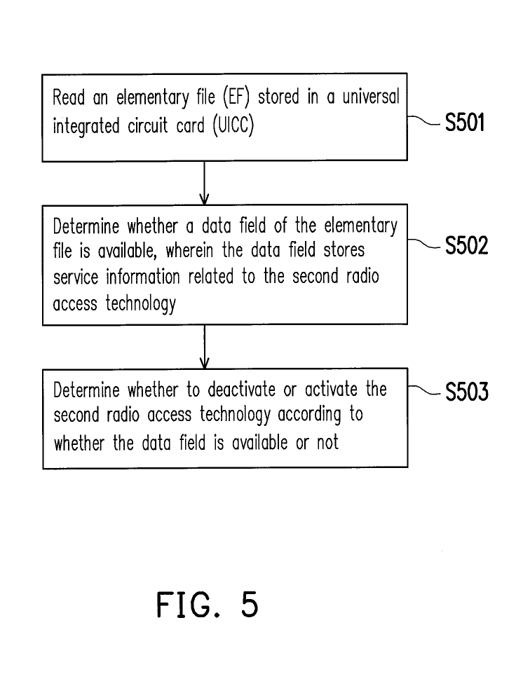

In order to facilitate understanding of an operation flow of the embodiment of the invention, a method for controlling capability of radio access technology is described in detail below with reference of an embodiment. FIG. 5 is a flowchart illustrating a method for controlling capability of radio access technology according to an embodiment of the invention. Referring to FIG. 5, the method of the present embodiment is adapted to the communication system 200 of FIG. 2 and the UE 230 of FIG. 3. In the following description, the method of the embodiment of the invention is described with reference of various components in the communication system 200 and the UE 230. Various steps of the method can be adjusted according to an actual application, and the invention is not limited to the provided method.

In step S501, the processor 236 reads an EF stored in the UICC 237. In detail, the processor 236 selects the EF and sends a read command to the UICC 237. The read command includes a position of data to be read. In step S502, the processor 236 determines whether a data field of the EF is available, wherein the data field stores service information related to the second RAT. In step S503, the processor 236 determines whether to deactivate or activate the second RAT according to whether the data field is available or not. Namely, when the processor 236 determines that the data field storing the service information related to the second RAT is not available, the processor 236 deactivates the second RAT (for example, stops executing a procedure related to the second RAT or turns off a power supply of a hardware device supporting the second RAT), so as to prevent the UE 230 from continuously trying to camp on the radio access network corresponding to the second RAT under a condition that the UICC 237 does not support the second RAT.

It should be noted that if the UE can determine to deactivate or activate the second RAT according to the data field during a power-on period of the UE, the UE loaded with the UICC not supporting the second RAT is avoided to perform a registration procedure with a base station supporting the second RAT. In this way, not only the power consumption of the UE is saved, a burden of the base station is also decreased.

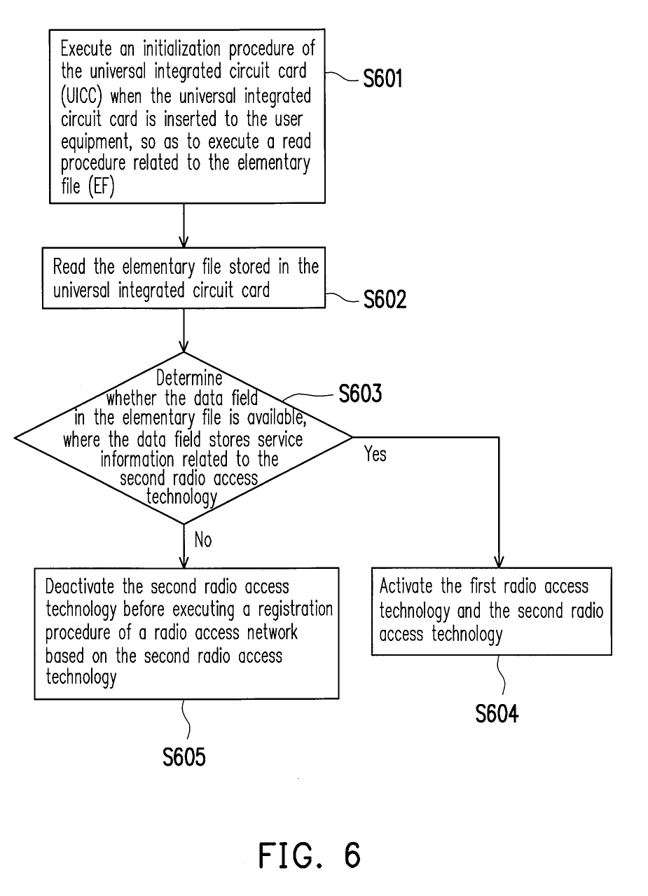

FIG. 6 is a flowchart illustrating a method for controlling capability of radio access technology according to an embodiment of the invention. The method of the present embodiment is adapted to the communication system 200 of FIG. 2 and the UE 230 of FIG. 3. In the following description, the method of the embodiment of the invention is described with reference of various components in the communication system 200 and the UE 230. Various steps of the method can be adjusted according to an actual application, and the invention is not limited to the provided method. In order to clearly describe the invention, in the embodiment, a situation that the first RAT is the 3G RAT and the second RAT is the 4G RAT is taken as an example for description, though the invention is not limited thereto. For example, in another embodiment, the first RAT is the 4G RAT and the second RAT is a fifth generation (5G) RAT.

Referring to FIG. 6, in step S601, when the UICC 237 is inserted into the UE 230, the processor 236 executes an initialization procedure of the UICC 237 to execute a read procedure related to the EF. In the present embodiment, when the processor 236 and the UICC 237 execute the initialization procedure of the UICC 237, the processor 236 request a plurality batches of data from the UICC 237, so as to perform an initialization configuration to a hardware device and a software device used for camping the radio access network.

It should be noted that the EF stored in the UICC 237 may include a USIM service table (UST) EF. The UST EF (EF_{UST}) includes a plurality of data fields, and each of the data fields respectively indicates whether a specific service is available. If one service is indicated as not available in the UST EF (EF_{UST}), the UE 230 cannot uses such service. Moreover, another EF probably exists based on that one service is indicated as available in the UST EF (EF_{UST}).

In step S602, the processor 236 reads the EF stored in the UICC, i.e. the UST EF (EF_{UST}). The processor 236 further determines whether a data field related to the 4G RAT exists in the UST EF (EF_{UST}), and data field is used for indicating whether a service n° XX (XX represents a referential number corresponding to the service) related to the 4G RAT is available or not. For example, the UST EF (EF_{UST}) includes a data field used for indicating whether a service n° 85 related to EPS mobility management information is available or not. When the service n° 85 related to the EPS mobility management information is available, the EPS NAS security contest EF (EF_{EPSNSC}) exists. The EF EF_{EPSNSC} includes related data used for executing a 4G network registration procedure.

In step S603, the processor 236 determines whether the data field is available, where the data field stores the service information related to the second RAT. To be specific, if the data field does not exist or the data field indicates that a service related to the second RAT is not available, the data field is not available. Comparatively, if the data field indicates that the service related to the second RAT is available, the data field is available. For example, the processor 236 determines whether the data field used for indicating the service n° 85 in the UST EF (EF_{UST}) is available. If the data field used for indicating the service n° 85 does not exist or the data field indicates that the service n° 85 is “not available”, the processor 236 determines that the data field is not available. Comparatively, if the data field indicates that the service n° 85 is “available”, the processor 236 determines that the data field is available.

If the data field used for indicating whether the service related to the second RAT is available or not is available, in step S604, the processor 236 activates the first RAT and the second RAT. Namely, if the UICC 237 reports that the service related to the second RAT is available, the processor 236 can simultaneously activates the first RAT and the second RAT. On the other hand, if the data field used for indicating whether the service related to the second RAT is available or not is not available, in step S605, the processor 236 deactivates the second RAT before executing the registration procedure of the radio access network based on the second RAT. To be specific, if the UICC 237 reports that the service related to the second RAT is not available, the processor 236 can directly deactivate the second RAT. Since the UE of the invention deactivates the second RAT during the period of executing the initialisation procedure to the UICC, the situation that the UE performs a registration procedure on a base station according to the second RAT that is not supported by the UICC is avoided.

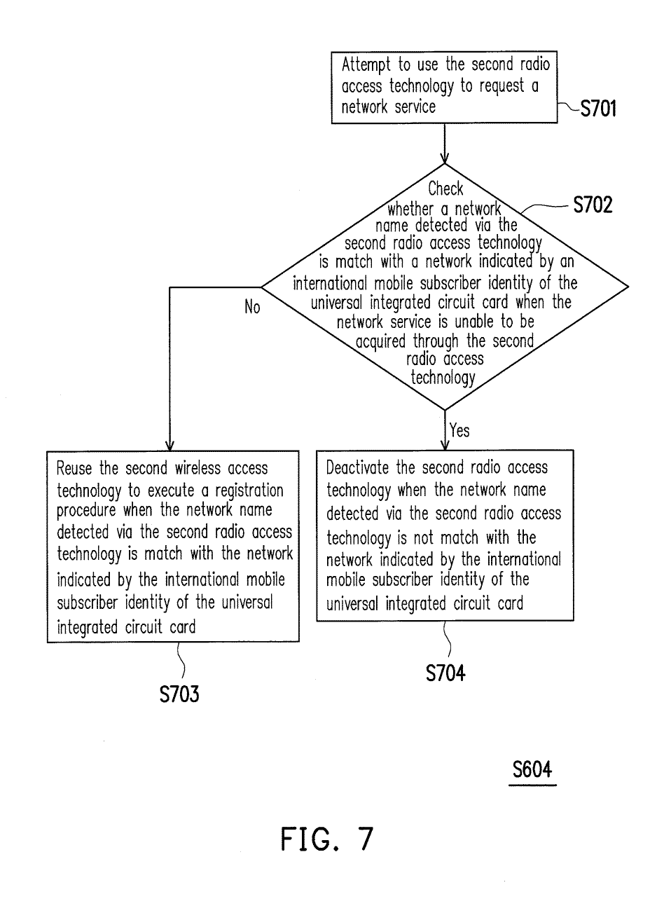

Moreover, FIG. 7 is a flowchart illustrating details of the step S604 of FIG. 6 according to an exemplary embodiment of the invention. Referring to FIG. 7, the step S604 may include following sub-steps. When the UE is power on, the processor 236 activates the second RAT based on that the aforementioned data field is available, and in step S701, the processor 236 attempts to use the second RAT to request a network service. In step S702, if the network service cannot be acquired through the second RAT (for example, the registration procedure is failed), the processor 236 checks whether a network name detected via the second RAT match with a network indicated by an international mobile subscriber identity (IMSI) stored in the UICC 237. If the network name detected via the second RAT does not match with the network indicated by the IMSI stored in the UICC 237, it presents that the UE 230 is not covered by a registered network which is available, and in step S703, the processor 236 directly deactivates the second RAT, so as to avoid generating a high roaming charge. If the network name detected via the second RAT match with the network indicated by the IMSI stored in the UICC 237, it presents that the network terminal probably rejects the registration of the UE due to a temporary reason, and in step S704, the processor 236 can retry the registration procedure later.

In summary, in the embodiment of the invention, when the UICC not supporting the second RAT is loaded to the UE supporting the second RAT, the UE can determine to deactivate or activate the second RAT according to whether the data field in the UICC is available. In this way, the UE is unnecessary to spend extra time and power to camp the radio access network that is unable to provide the service, so as to avoid a situation that the UE is switched to “no service” due to that the UICC does not support the second RAT. Moreover, the base station is unnecessary to spend time and radio resources to reject the registration of the UE, so as to decrease a burden of the base station to make an effectively use of the radio resources.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for controlling capability of radio access technology, adapted to a user equipment supporting a first radio access technology and a second radio access technology, the method for controlling capability of radio access technology comprising:
reading an elementary file stored in a universal integrated circuit card;
determining whether a data field of the elementary file is available, wherein the data field stores service information related to the second radio access technology; and
determining whether to deactivate or activate the second radio access technology according to whether the data field is available or not.

2. The method for controlling capability of radio access technology as claimed in claim 1, wherein before reading the elementary file stored in the universal integrated circuit card, the method further comprises:
executing an initialization procedure of the universal integrated circuit card when the universal integrated circuit card is inserted into the user equipment, so as to execute a read procedure related to the elementary file, wherein the elementary file comprises a service table of the universal integrated circuit card.

3. The method for controlling capability of radio access technology as claimed in claim 1, wherein when the data field does not exist or the data field indicates that a service related to the second radio access technology is not available, the data field is not available; and when the data field indicates that the service related to the second radio access technology is available, the data field is available.

4. The method for controlling capability of radio access technology as claimed in claim 1, wherein determining whether to deactivate or activate the second radio access technology according to whether the data field is available or not comprises:
activating the first radio access technology and the second radio access technology when the data field is available; and
deactivating the second radio access technology before executing a registration procedure of a radio access network based on the second radio access technology when the data field is not available.

5. The method for controlling capability of radio access technology as claimed in claim 1, further comprising:
checking whether a network name detected via the second radio access technology match with a network indicated by an international mobile subscriber identity of the universal integrated circuit card when a network service is unable to be acquired through the second radio access technology;
deactivating the second radio access technology when the network name detected via the second radio access technology does not match with the network indicated by the international mobile subscriber identity of the universal integrated circuit card; and
reusing the second wireless access technology to execute a registration procedure when the network name detected via the second radio access technology match with the network indicated by the international mobile subscriber identity of the universal integrated circuit card.

6. The method for controlling capability of radio access technology as claimed in claim 1, wherein the elementary file comprises a universal subscriber identity module service table elementary file, and the data field indicates whether a service related to evolved packet system mobility management information is available or not, wherein when the service related to the evolved packet system mobility management information is available, an evolved packet system non-access stratum security contest elementary file exists.

7. A user equipment, supporting a first radio access technology and a second radio access technology, comprising:
a transceiver, configured to transmit and receive a radio signal;
a storage unit, configured to store network information related to a radio access network;
a processor, coupled to the transceiver and the storage unit, and configured for executing:
reading an elementary file stored in a universal integrated circuit card;
determining whether a data field of the elementary file is available, wherein the data field stores service information related to the second radio access technology; and
determining whether to deactivate or activate the second radio access technology according to whether the data field is available or not.

8. The user equipment as claimed in claim 7, wherein before the step of reading the elementary file stored in the universal integrated circuit card, the processor is configured for executing:
executing an initialization procedure of the universal integrated circuit card when the universal integrated circuit card is inserted into the user equipment, so as to execute a read procedure related to the elementary file, wherein the elementary file records a service table of the universal integrated circuit card.

9. The user equipment as claimed in claim 7, wherein when the data field does not exist or the data field indicates that a service related to the second radio access technology is not available, the data field is not available; and when the data field indicates that the service related to the second radio access technology is available, the data field is available.

10. The user equipment as claimed in claim 7, wherein the processor is configured for executing:
activating the second radio access technology when the data field is available; and
deactivating the second radio access technology before executing a registration procedure of a radio access network based on the second radio access technology when the data field is not available.

11. The user equipment as claimed in claim 7, wherein the processor is configured for executing:
checking whether a network name detected via the second radio access technology match with a network indicated by an international mobile subscriber identity of the universal integrated circuit card when a network service is unable to be acquired through the second radio access technology;
deactivating the second radio access technology when the network name detected via the second radio access technology does not match with the network indicated by the international mobile subscriber identity of the universal integrated circuit card; and
reusing the second wireless access technology to execute a registration procedure when the network name detected via the second radio access technology match with the network indicated by the international mobile subscriber identity of the universal integrated circuit card.

12. The user equipment as claimed in claim 7, wherein the elementary file comprises a universal subscriber identity module service table elementary file, and the data field indicates whether a service related to evolved packet system mobility management information is available or not, wherein when the service related to the evolved packet system mobility management information is available, an evolved packet system non-access stratum security contest elementary file exists.
